(19) United States
(12) Patent Application Publication
(10) Pub. No.: US 2024/0402950 A1
(43) Pub. Date: Dec. 5, 2024

(54) PRINTING CONTROL DEVICE, METHOD OF CONTROLLING PRINTING CONTROL DEVICE, AND STORAGE MEDIUM

(71) Applicant: CANON KABUSHIKI KAISHA, Tokyo (JP)

(72) Inventor: Yumi Ikarashi, Kanagawa (JP)

(21) Appl. No.: 18/668,347

(22) Filed: May 20, 2024

(30) Foreign Application Priority Data
May 31, 2023 (JP) 2023-089446

(51) Int. Cl. G06F 3/12

(52) U.S. Cl. CPC G06F 3/1204; G06F 3/1205; G06F 3/1257; G06F 3/1258

(57) ABSTRACT

A printing control device includes: an operation information obtainment unit that obtains operation information on a printing device; and a display control unit that displays, on a display screen to select a parameter set, a candidate selected from a plurality of parameter sets registered with the printing device based on the operation information on the printing device.

### BACKGROUND

### Field

The present disclosure relates to a printing control device, a method of controlling the printing control device, and a storage medium.

### Description of the Related Art

There is a printing medium having a multilayer structure including a sheet that is attached to a backing sheet and called a sticker or a label. Because of its usage, a material having an arrestive color or weather resistance is used for the above printing medium. There are many colors or types of the printing media including a material colored in gold, silver, or other colors, a material of paper or film, and the like. In order to implement optimal printing on the printing media having those various characteristics, it is possible to set many printing parameters in the printer. A combination of multiple printing parameters allows for printing on the printing medium under optimal conditions. An example of the parameter necessary for printing may include a printing speed, a color ink application amount, a drying temperature after color printing, whether to perform white printing to print a design or a character with a white ink, a white ink application amount, a drying temperature after the white printing, setting of a color profile to be used, and the like. The white ink is used as a background of the color printing and has an effect to prevent the transparency of the color printing and the like. A user sets those printing parameters in association with the printing medium and performs printing.

Japanese Patent Laid-Open No. 2007-283717 discloses a technique in which, in a case where there are many printing parameters to set, a setting candidate, which is registered with a database in advance and related to a setting value A received through a setting screen, is searched from the database and displayed so as to allow the user who is unfamiliar with the operation to set the various types of parameters.

### SUMMARY

There has been demanded a technique of selecting a parameter set registered with a device more efficiently.

A printing control device according to an aspect of the present disclosure includes: an operation information obtainment unit that obtains operation information on a printing device; and a display control unit that displays, on a display screen to select a parameter set, a candidate selected from multiple parameter sets registered with the printing device based on the operation information on the printing device.

Further features of the present invention will become apparent from the following description of exemplary embodiments with reference to the attached drawings.

### BRIEF DESCRIPTION OF THE DRAWINGS

FIG. 1 is a configuration diagram of an image formation apparatus;

FIG. 2 is a functional block diagram of the image formation apparatus;

FIG. 3 is a basic flowchart of printing;

FIG. 4 is an example of a printing job list screen;

FIG. 5 is an example of a printing parameter editing screen;

FIGS. 6A and 6B are examples of a pull-down screen;

FIG. 7 is an example of a pop-up screen;

FIG. 8 is an example of a pop-up screen;

FIG. 9 is an example of an adjustment function selection UI screen;

FIG. 10 is a flowchart of control of displaying the pop-up screen;

FIG. 11 is a flowchart of creating a color profile;

FIG. 12 is a screen of a printing parameter set list;

FIG. 13 is a flowchart of selecting a candidate of a printing parameter set;

FIG. 14 is a flowchart of selecting the candidate based on image formation apparatus operation information;

FIG. 15 is an example of a candidate display order table allocated based on the operation information;

FIG. 16 is a flowchart of selecting the candidate of the printing parameter set;

FIG. 17 is a flowchart of selecting the candidate based on filter setting information;

FIG. 18 is an example of a priority definition table for each printing parameter; and

FIG. 19 is an example of a candidate display order table allocated based on the filter setting information.

### DESCRIPTION OF THE EMBODIMENTS

Preferred embodiments of the present disclosure are described below in detail with reference to the appended drawings. Note that, the following embodiments are not intended to limit the present disclosure according to the scope of claim, and not all the combinations of the characteristics described in the present embodiments are necessarily required for the means for solving the problems of the present disclosure.

### Embodiment 1

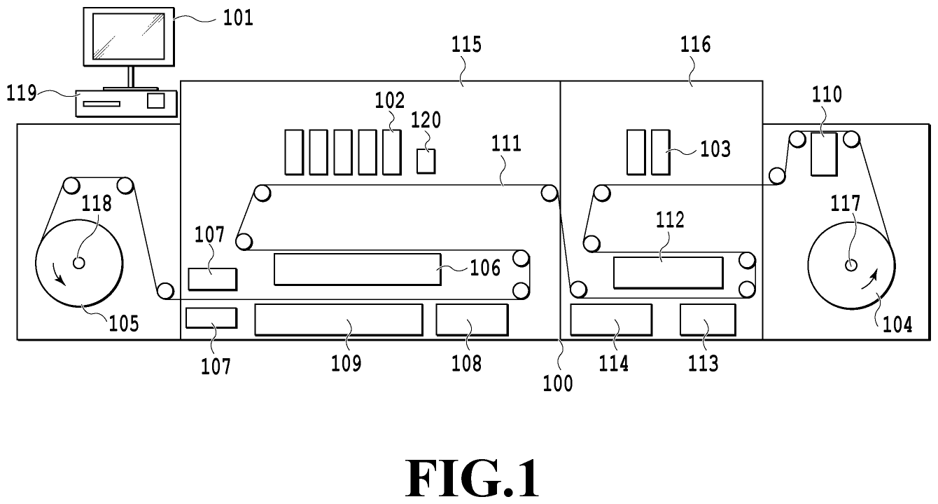

A configuration of an image formation apparatus in the present embodiment is described. FIG. 1 is an example of a schematic configuration of an image formation apparatus 100 according to the present embodiment. The image formation apparatus 100 is an apparatus that forms an image on a continuous printing medium (hereinafter, roll paper) 111 that is used in the present embodiment and allows for continuous image formation. In the present embodiment, the image formation apparatus 100 includes a feeding device 104 that feeds the roll paper 111 and a printing unit 116 that performs special color printing. In addition, the image formation apparatus 100 includes a printing unit 115 that performs basic color printing, a rolling-up device 105 that rolls up the roll paper 111, and a user interface (hereinafter, UI) operation panel 101. The feeding device 104 is a device that supplies the roll paper 111 to the image formation apparatus 100. The feeding device 104 rotates a paper tube of the roll paper 111 about a rotation shaft 117 and conveys the roll paper 111 rolled up around the paper tube to the image formation apparatus 100 at a constant speed by way of multiple rollers (a conveyance roller, a feeding roller, and so on). The rolling-up device 105 is a device that rolls up the roll paper 111 conveyed from the image formation apparatus 100 about the paper tube in a rolled shape. The paper tube is attached to a rotation shaft 118, and with the rotation of the paper tube about the rotation shaft 118, the roll paper 111 conveyed to the paper tube by way of multiple rollers (for example, a conveyance roller and a discharge roller) is rolled up at a predetermined speed as a printed deliverable. The printed deliverable is rolled up around the paper tube and held in a rolled shape. As an operation before starting the printing, the roll paper 111 is put through from the feeding device 104 to the rolling-up device 105. The roll paper 111 is set on the feeding device 104, and a tip of the roll paper 111 passes above a skew correction device 110. Next, the roll paper 111 passes under a printing device 103 of the printing unit 116. The printing device 103 in the present embodiment is a device that performs printing with a white ink, for example, which is an ink of a color other than cyan (C), magenta (M), yellow (Y), and black (K) (CMYK) of color inks. The roll paper 111 passes under a dryer device 112 and passes above cooler devices 113 and 114. Next, the roll paper 111 passes under a mark detection sensor 120 and a printing device 102 of the printing unit 115, passes under a dryer device 106, and passes above cooler devices 108 and 109. In the present embodiment, the mark detection sensor 120 is used for positioning in a case of forming an image formed by the printing device 102 on an image formed by the printing device 103; however, it is not limited thereto, and a scanner device may be used. The printing device 102 of the present embodiment is a device that prints a printing basic color (CMYK). The roll paper 111 passes through a connected scanner device 107 and is rolled up around the rolling-up device 105. After the roll paper 111 is put through the inside of the image formation apparatus 100, a printing job is inputted to a control PC (a printing control device) 119 of the image formation apparatus 100. After the printing job is inputted, a printing start button is pressed on the UI operation panel 101, and the printing is started. The printed image is read by the scanner device 107, the control PC 119 analyzes the read image, and an examination is performed to see whether the printed product has no problem. Additionally, the control PC 119 can perform editing processing on the inputted printing job.

Next, a control configuration of the image formation apparatus 100 is described in detail.

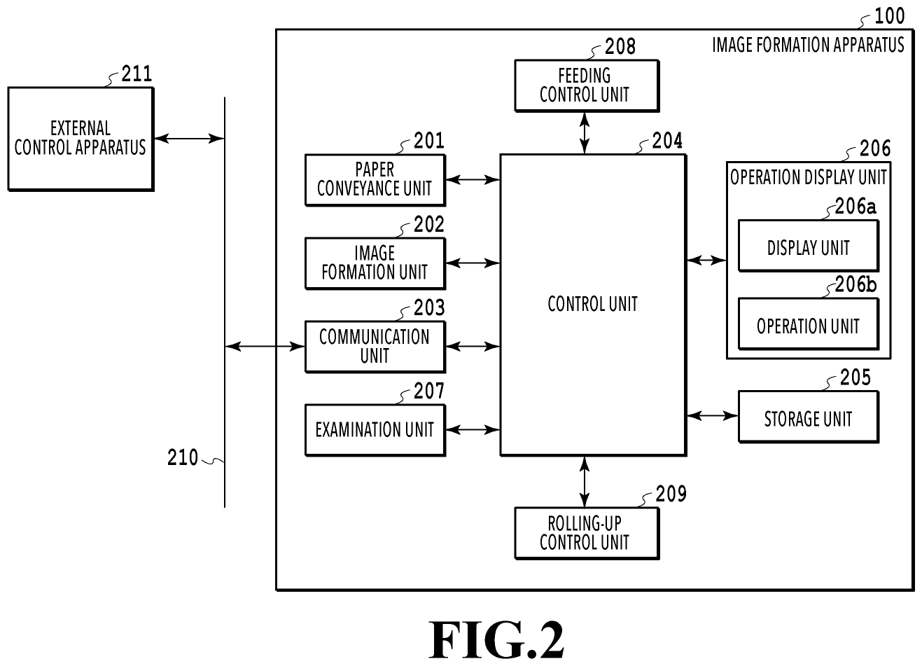

FIG. 2 is a functional block diagram illustrating the control configuration of the image formation apparatus 100. As illustrated in FIG. 2, the image formation apparatus 100 includes a paper conveyance unit 201, an image formation unit 202, a communication unit 203, a control unit 204, a storage unit 205, an operation display unit 206, an examination unit 207, a feeding control unit 208, and a rolling-up control unit 209. The paper conveyance unit 201 is a conveyance mechanism of the roll paper 111 inside the image formation apparatus 100. For example, with multiple rollers, the roll paper 111 conveyed from the feeding control unit 208 is conveyed to the image formation unit 202, and the roll paper 111 that passes through the image formation unit 202 is conveyed to the rolling-up control unit 209. The image formation unit 202 forms an image on the roll paper 111 supplied from the feeding control unit 208 based on printing data responding to an output instruction. The image formation unit 202 conveys the roll paper 111 on which the image is formed to the rolling-up control unit 209. The communication unit 203 includes, for example, a communication control card such as a local area network (LAN) card. Various types of data is transmitted and received between an external control apparatus 211 (for example, a personal computer) connected to a communication network 210 such as a LAN or a wide area network (WAN). A printing application and the like necessary for printing are installed in the external control apparatus 211.

The control unit 204 includes, for example, a central processing unit (CPU), a random access memory (RAM), and the like. The CPU of the control unit 204 reads various programs such as a system program and a processing program stored in the storage unit 205 to deploy the programs to the RAM and executes various types of processing according to the deployed programs. For example, the control unit 204 can perform image formation processing to execute an image formation job (hereinafter, referred to as a job) according to an instruction from the user. The storage unit 205 includes, for example, a non-volatile semiconductor memory (a so-called flash memory), a hard disk drive (HDD), or the like. The storage unit 205 stores various programs such as a system program and a processing program executed by the control unit 204 and various types of data necessary to execute those programs. The operation display unit 206 includes, for example, a liquid crystal display (LCD) with a touch panel and includes a display unit 206a and an operation unit 206b. The display unit 206a displays various types of information on a display screen according to a display control signal inputted from the control unit 204. The operation unit 206b includes various operation keys such as a numeric keypad and a start key, receives various input operations from the user, and outputs an operation signal to the control unit 204. The operation display unit 206 is used in a case of setting job information in executing the job, for example. The user can arbitrarily set any conditions such as the paper to use, information on a printing speed, the number of sheets to be printed, the number of prints, a printing length, and a printing diameter.

Next, an operation in a case where the image formation processing is performed on the roll paper 111 in the image formation apparatus 100 is described. First, the user uses an external device to create data of the printing job, perform the printing setting and setting of the delivered number of rolls of the job, and transmit the information to the image formation apparatus 100 through a communication network. By way of the communication unit 203, the control unit 204 of the image formation apparatus 100 receives data of the job and a job ticket including printing setting information, delivered number of rolls information, and the like of the job that are transmitted from the external device. The examination unit 207 is a device that confirms whether printing is performed on a printing image sheet with no ejection failure. Whether there is no ejection failure on the printing image is confirmed by printing a detection pattern for the ejection failure examination and reading the pattern by a scanner. In a case where an ejection failure is detected, the image formation apparatus is paused. The examination method may include various methods such as the method of printing the detection pattern and reading the pattern by the scanner, a method of directly reading the printing image by a camera or the scanner to examine, and a method of monitoring an ejection status from a nozzle. The present embodiment applies a configuration in which whether there is no ejection failure is confirmed by the method of printing the detection pattern and reading the pattern by the scanner.

Next, a basic flowchart of printing by the image formation apparatus 100 is described in sequence.

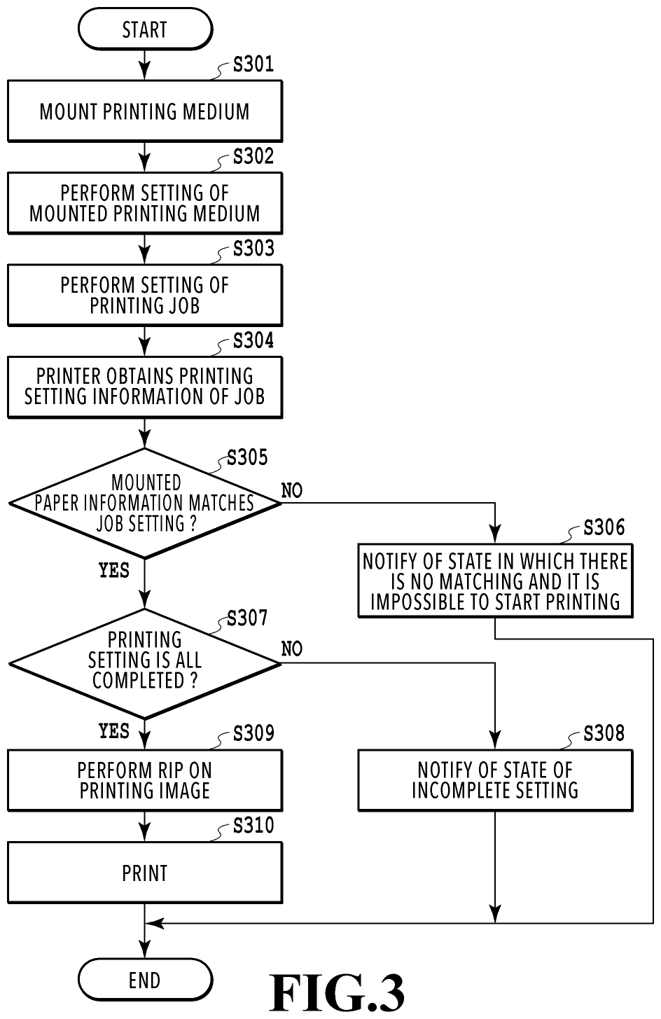

FIG. 3 is a basic printing flowchart and describes a flow from attaching the printing medium to the image formation apparatus 100 to printing. In processing in the present flowchart, the CPU of the control unit 204 reads various programs such as the system program and the processing program stored in the storage unit 205 to deploy the programs to the RAM and executes various types of processing according to the deployed programs. Additionally, a sign “S” in each description of the processing in the present flowchart means a step in the flowchart, and the same applies to the subsequent flowcharts.

First, in S301, the printing medium is mounted on the feeding device 104 of the image formation apparatus 100. In the present embodiment, the printing medium is rolled up in a rolled shape. While the printing medium rolled up in the rolled shape is drawn out along a path of a conveyance mechanism of the printer by way of multiple conveyance rollers, the printing medium is fixed around a rolling-up core attached to the rolling-up device 105, which is a terminal end of the conveyance path. In S302, before printing processing is started, the user performs setting of the printing medium mounted in the printer. The present setting is performed by designation from printing media registered with the printer in advance. Thus, it is possible to set an optimal conveyance parameter associated with printing medium information stored in advance and to properly convey the attached printing medium.

Additionally, in addition to the conveyance parameter, the parameter set to the printing job includes whether to perform white printing, a hiding rate in the white printing, a drying temperature after the white printing or a drying temperature in color printing, and a tension applied to the printing medium. In addition, it may be considered that the parameter includes a type of ink to use, a type of color profile to use in color matching, and the like. Note that, those printing parameters are an example, and the present embodiment is not limited thereto. In a case where there is no printing medium same as that mounted in the printer on the displayed list, the one with physical characteristics or a feature close to that of the attached printing medium is selected. The physical characteristics are a type of material of the printing medium (coated paper, high-quality paper, a film, or the like), a thickness, a width, or a basis weight of the printing medium, and the like.

In S303, the printing job in which data to be printed, the medium on which printing is performed, or the printing setting is described is set by the user. Note that, the processing in S302 and S303 is executed with the user operating the control PC (the printing control device) 119 of the image formation apparatus 100. The created printing job is transmitted to the image formation apparatus 100. In S304, the control unit 204 of the image formation apparatus 100 obtains the printing setting information including the printing job set by the user of the image formation apparatus 100. Then, the printing job included in the printing setting information is analyzed.

In S305, before printing is started, the image formation apparatus 100 determines whether the printing medium designated by the printing job and the printing medium mounted in the printer match. If the printing medium designated by the printing job and the printing medium mounted in the printer do not match, the control unit 204 allows the process to proceed to S306 and notifies the user of that it is impossible to start printing. If the printing medium designated by the printing job and the printing medium mounted in the printer match, the control unit 204 allows the process to proceed to S307 and determines whether the printing setting necessary for printing is all completed. If it is determined in S307 that the printing setting necessary for printing is not completed, the control unit 204 allows the process to proceed to S308 and notifies the user of the state of incomplete setting. If it is determined that the printing setting necessary for printing is all set, the control unit 204 allows the process to proceed to S309 and performs raster image processor (RIP) processing of the printing image data designated by the printing job.

In the RIP processing, it is possible to perform processing of converting vector image data, which is image data described by a command, into raster image data, which is a collection of printing pixels. Additionally, there may also be processing with a color conversion function to convert a color of the printing data. In S310, the control unit 204 executes printing of the printing image data created by an RIP. Thereafter, the control unit 204 ends the processing in the present flowchart.

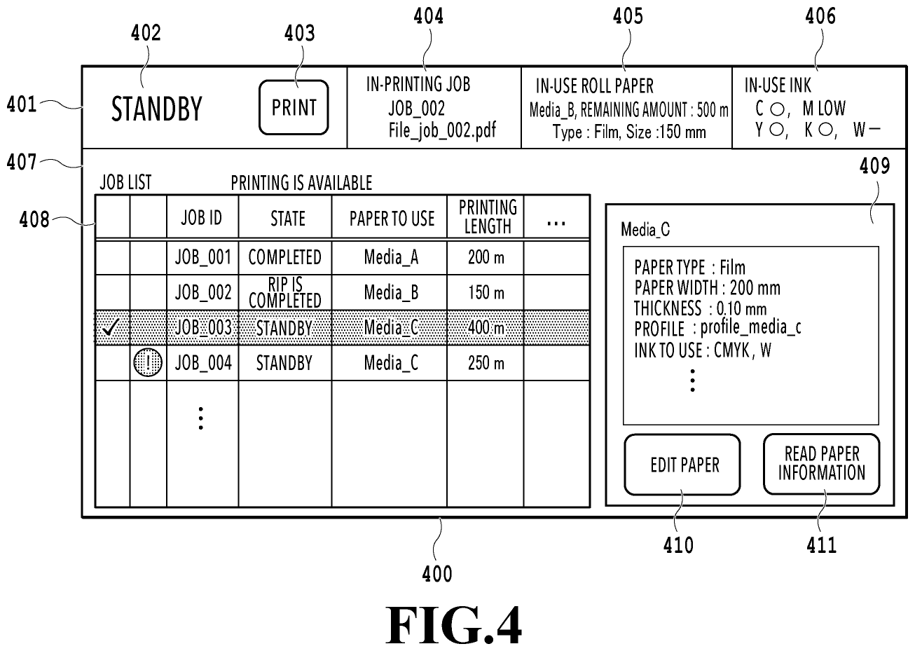

FIG. 4 is an example of a UI screen displaying a list of the printing jobs. In FIG. 4, a whole UI screen 400 is the entirety of the UI displayed on the UI operation panel 101. A status display area 401 displays brief information related to a state of the image formation apparatus 100 such as a current state of the image formation apparatus 100 and information on the job that is in printing. An operation status display 402 of the image formation apparatus 100 indicates a status of the image formation apparatus 100. In FIG. 4, it is “standby” indicating waiting for printing. In addition to “standby”, an operation status includes a state such as “pausing” and “printing”. Printing of the selected printing job is started by pressing a print button 403. An in-printing job display 404 displays a name of the job to be printed. A printing medium information display 405 displays a name and a remaining amount of the printing medium attached to the image formation apparatus 100. An ink state display 406 displays a type and a state of the remaining amount of the ink being used.

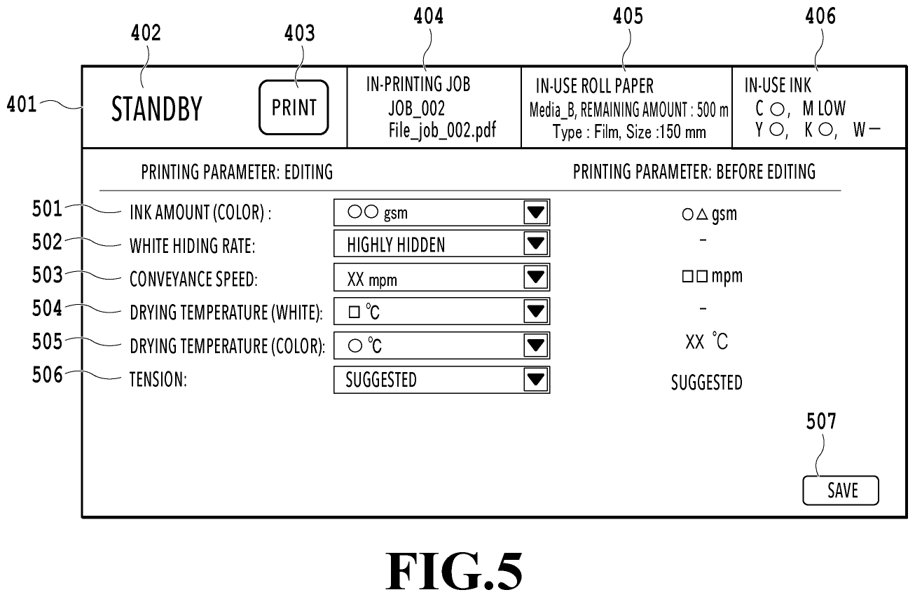

In the present embodiment, an example indicating the operation status display of the image formation apparatus 100, the print button, the in-printing job display, the printing medium information display, and the ink state display as contents of the status display area 401 is described; however, it is not limited thereto, and a state other than the described states may be displayed. A working area 407 is a working area for an operation by the user. In a case of confirming detail information related to each piece of the information in the status display area 401, it is possible to display the detail information in the working area 407 of the related detail information by pressing each state display region of the status display area 401. For example, it is possible to switch the display to the display of the printing job list in FIG. 4 by pressing the in-printing job display 404. A method of switching the screen is not limited thereto, and a menu screen may be additionally provided, and the screen may be switched by selecting a menu. A printing job list 408 displays an ID and a current state of the printing job and information on the printing medium and the like. The image formation apparatus 100 starts printing by pressing the print button 403 for the job selected from the list. A printing medium information display 409 displays detail information on the printing medium. A paper edit button 410 can edit the information on the printing medium that is displayed in the printing medium information display 409. An editing screen of the printing medium is illustrated in FIG. 5. A paper information read button 411 is used in a case of reading new paper information other than the paper information currently set. The setting read by the paper information read button 411 is displayed in the printing medium information display 405 as information on the printing medium attached to the image formation apparatus 100.

FIG. 5 is a UI screen to edit the printing parameter. In a case where no information on a printing base material is registered with the image formation apparatus 100, it is necessary to select the already-registered printing medium that has the physical characteristics or the feature close to that of the printing medium mounted in the image formation apparatus 100. However, it is a printing parameter optimized for merely a similar printing medium and may not be appropriate for the printing medium of the user. In the above case, it is possible to create a combination of the printing parameters optimized for the printing medium of the user by changing the printing parameter.

The UI screen to edit the printing parameter that is illustrated in FIG. 5 can be displayed on a part of the whole UI screen 400 by pressing the paper edit button 410 in FIG. 4. A parameter set illustrated in FIG. 5 includes ink amount (color) 501, white hiding rate 502, conveyance speed 503, drying temperature (white) 504, drying temperature (color) 505, and tension 506. The user can select a setting value of each parameter from a pull-down menu of each parameter.

In the ink amount (color) 501, it is possible to select the maximum amount of the color ink amount applied in printing. With an increase of the color ink amount to be applied, it is possible to expect expansion of printing color gamut and improvement of the maximum color density in printing, and it is possible to further improve the color reproducibility of a printing result. However, with an increase of the ink amount, a problem occurs depending on the printing medium, such as that the ink cannot be fixed or cannot be sufficiently dried after printing; therefore, it is necessary to change the ink amount taking into consideration a relationship between the properties of the printing medium and the printing conditions (the drying temperature or the conveyance speed).

In the white hiding rate 502, it is possible to select the hiding rate in the white printing. As an application of the printing with the white ink, a case where a design or a character is desired to be printed with the white ink may be considered. In addition, there is a case where the printing with the white ink is performed for a background of the color printing. The background is printed with the white ink, and the color printing is performed thereon; thus, it is possible to perform the color printing without an effect of a ground color of the printing medium. Additionally, in a case of a transparent printing medium, it is possible to prevent the transparency of a color printing portion by the background printing. In a case where background treatment is not performed with the white ink, the printing result is affected by the ground color of the printing medium and has an abnormal color.

In the conveyance speed 503, it is possible to select a conveyance speed of the printing medium. The image formation apparatus 100 of the present embodiment has a configuration to perform printing on the printing medium rolled up in a rolled shape and to roll up the printed product into the rolled shape again after printing. The faster the conveyance speed of the printing medium is, the more the printing amount per unit time can be increased, and the production efficiency is improved. However, the high-speed conveyance may cause insufficient drying after printing. Accordingly, it is desirable to determine the conveyance speed taking into consideration a mutual relationship between the characteristics of the printing medium, the ink application amount, and the drying temperature.

In the drying temperature (white) 504, it is possible to select the temperature of a drying mechanism after printing with the white ink. In a case where the conveyance speed of the printing medium is fast, adjustment such as setting a high drying temperature is necessary to obtain sufficient dryness. Additionally, depending on the printing medium such as a film or a type of an adhesive applied to the printing medium for a sticker, there is a possibility that printing jamming occurs due to contraction and deformation of the printing medium and the softened adhesive because of the high temperature. Therefore, it is necessary to set the drying temperature to an optimal value after identifying the characteristics of the printing medium.

In the drying temperature (color) 505, it is possible to select the temperature of a dryer after printing with the color ink. As with the drying temperature (white) 504, it is necessary to set an optimal value according to a combination of the characteristics of the printing medium and the printing parameter.

In the tension 506, it is possible to select the tension applied to the printing medium in the image formation apparatus 100 that conveys the printing medium by roll-to-roll. In a case where the tension is weak, a problem occurs such as loosening in the middle of the conveyance path of the printing medium, which may prevent the conveyance at a constant speed, and jamming in the middle of the conveyance. On the other hand, in a case where the set tension is too strong, there is a possibility that the printing medium is deformed or broken; therefore, it is necessary to select a proper value according to the printing medium. A save button 507 can save the changed printing parameter by being pressed.

In the parameter editing screen illustrated in FIG. 5, in a case of looking for an optimal combination of the printing parameters while changing the multiple printing parameters, in some cases, it may be difficult to determine which print parameters have been changed and which have not. Therefore, as illustrated in FIG. 5, the editing screen also displays the printing parameter before editing, and the user can constantly confirm the printing parameter before editing and can easily return to the state before the editing is started.

As described so far, since the printing parameters each have a mutual relationship, once one printing parameter is changed, an option of the other parameter may be changed. As an example of this case, a difference of a conveyance speed selection pull-down menu between a case of only the color printing and a case of the color printing and the white printing is described.

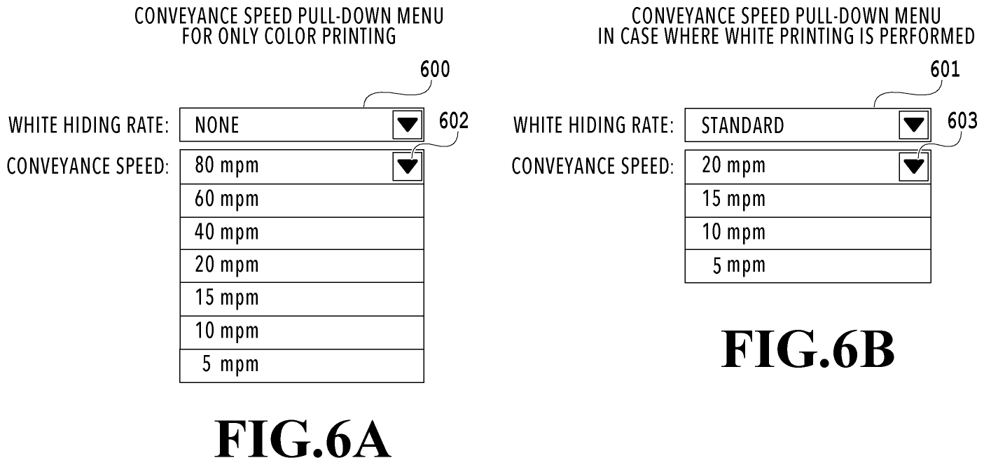

FIGS. 6A and 6B are diagrams illustrating an example of the pull-down menu. As described above, the white printing is used for the background printing to cover the effect of the ground color of the printing medium or the background printing to prevent the transparency of a transparent film. Therefore, in the white printing, more amount of the ink per unit area is used for the printing than the general color printing, and thus it is necessary to set the conveyance speed slower than that in a case of only the color printing. Therefore, in a case of performing the white printing, options of the conveyance speed displayed in a conveyance speed selection 603 are different from that in a case of only the color printing.

In FIG. 6A, the white printing is not set in a white hiding rate selection menu 600; thus, only the color printing is performed. A conveyance speed selection 602 indicates a state of the pull-down menu of the conveyance speed in a case where only the color printing is performed. In a case of only the color printing in the present embodiment, the maximum value of the conveyance speed is 80 mpm. The conveyance speed of 80 mpm is an example, and this numerical value itself has no effect on the present embodiment.

In contrast, in FIG. 6B, a white hiding rate selection menu 601 indicates a state in which standard is set as the selected white hiding rate. In a case where the white printing is performed, the maximum value of the conveyance speed selection 603 is limited to 20 mpm, and it can be seen that the maximum value of the conveyance speed is more limited than that in a case of only the color printing. As the pull-down menu is displayed with the maximum value of the conveyance speed being changed in the white printing, the user is prevented from selecting the parameter of the conveyance speed that cannot be set in the white printing. Note that, although FIG. 6 illustrates a configuration to select the setting value of the conveyance speed from multiple candidates displayed by the pull-down menu, the present embodiment is not limited thereto, and another mode may be applied as long as it is a configuration that allows for selection from multiple candidates.

Here, in a case where the color ink amount of the printing parameter is changed in the ink amount (color) 501 in FIG. 5, the color development characteristics of the printing result are changed due to a change in the printing color gamut and a change in the color density in printing. Therefore, it is desirable to perform a readjustment operation of the image formation apparatus 100. For example, since the color development characteristics are changed in a case where the color ink amount is changed, in order to perform the printing correctly with a desired color, it is desirable to recreate the color profile used in color matching processing. However, it is considered that it is difficult for the user to construe the relationship between the change in the printing parameter and the printing result and to perform various readjustment operations that should be performed by the image formation apparatus 100, such as the recreation of the color profile, with no mistakes.

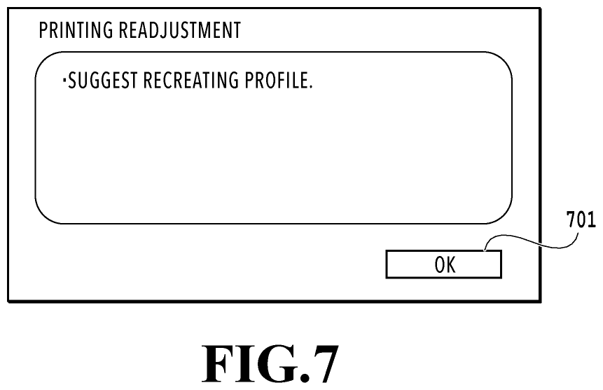

FIG. 7 is an example of a pop-up display screen. Specifically, FIG. 7 is a pop-up screen to provide a notification to the user in a case where the user tries to change the color ink amount of the printing parameter in the ink amount (color) 501 in FIG. 5. The user can recognize from the displayed pop-up screen that it is desirable to recreate the color profile if the user changes the color ink amount. In a case where the ink amount is changed, but the color profile is not recreated, no correct color reproduction by the color matching processing can be expected. Additionally, there is a possibility of not only the inaccurate color reproduction but also inefficient use of the color gamut expanded by changing the ink amount. On the other hand, in order to recreate the color profile, it is necessary to print a profile creation patch image, measure the color, and create the color profile by computation processing using the colorimetry result, and a certain amount of person-hours are necessary. The recreation of the color profile is suggested in a case where the color ink amount is changed; however, it is not processing to be performed necessarily. Accordingly, with a reminder using the pop-up display in a case of trying to change the ink amount, the user can consider whether to change the ink amount by comparing a merit from changing the ink amount and time and effort to create the color profile.

It is possible to close the pop-up display screen by pressing an OK button 701 in the pop-up display screen in FIG. 7. Additionally, although the user is notified by the pop-up display in FIG. 7, a mode in which a reminder text is displayed in a predetermined area on the UI screen may be applied.

In FIG. 7, the user is notified of that it is necessary to recreate the color profile in a case of changing the printing parameter of the color ink amount in a case of printing by the image formation apparatus 100; however, the notified contents are not limited thereto. For example, it is possible to remind the user with the pop-up display in a case of changing a specific parameter that causes processing to perform readjustment of the image formation apparatus 100 such as calibration or adjustment of the ink ejection amount of the printing head.

As another example of the adjustment operation performed by the image formation apparatus 100, correction of the conveyance length of the printing medium is described. In FIG. 5, it is possible to change the conveyance speed of the printing medium of the printing parameter in the conveyance speed selection menu 503. The image formation apparatus 100 described in the present embodiment is the roll-to-roll image formation apparatus 100 and performs the conveyance operation by applying a constant tension to the printing medium. Therefore, since the printing medium is deformed in a conveyance direction, conveyance direction length correction processing is necessary. The conveyance length direction correction processing is related to the conveyance speed, and in a case where the conveyance speed of the printing medium is changed, it is necessary to perform the conveyance direction length correction processing at the changed conveyance speed.

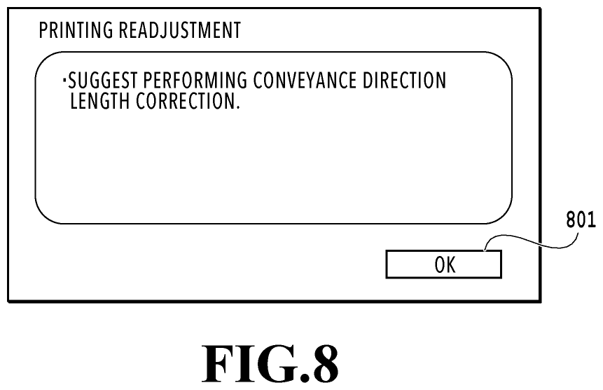

FIG. 8 is a diagram illustrating an example of a pop-up screen. Specifically, it is a pop-up screen to provide a notification to the user in a case where the conveyance speed of the printing medium is changed in the conveyance speed selection menu 503 in FIG. 5. The user can recognize from the displayed pop-up screen that it is necessary to perform the conveyance length direction correction processing if the conveyance speed is changed. In a case where the conveyance length direction correction processing is not performed, depending on the type of the printing medium, accurate conveyance of the printing medium and drawing during printing may be affected. It is possible to close the pop-up screen once displayed by pressing an OK button 801.

In a case where the save button 507 in FIG. 5 is pressed after the pop-up display screen as illustrated in FIG. 7 or 8 is displayed, a transition to a screen to perform the adjustment operation displayed by the pop-up (for example, the profile recreation or the conveyance length direction correction) is made.

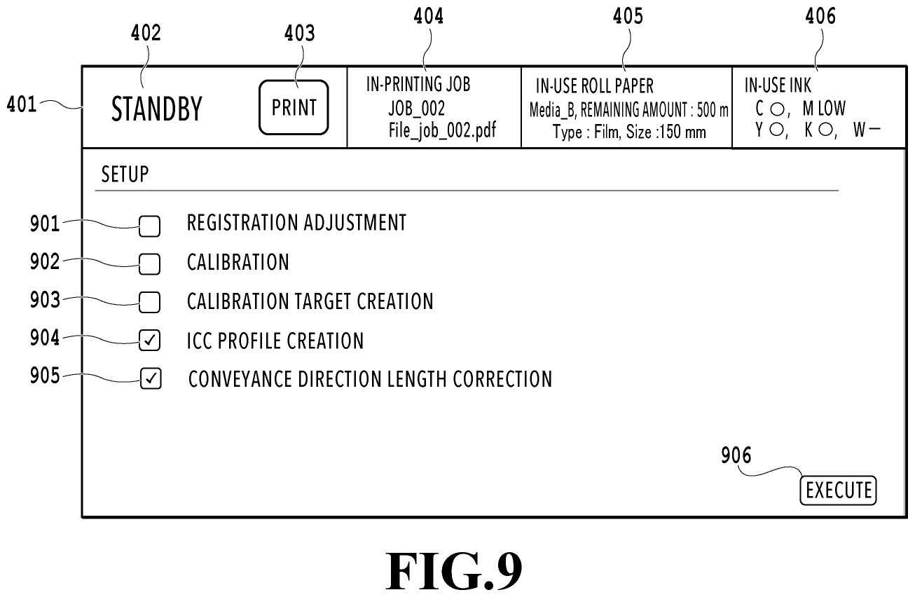

FIG. 9 is a diagram illustrating an adjustment function selection UI screen. A transition to the adjustment function selection UI screen is made in a case where the save button 507 is pressed after editing of the printing parameter is received in FIG. 5. In FIG. 9, the same reference numeral is applied to a function same as that in FIG. 4. A registration adjustment function 901 is a function to adjust a relative positional relationship of print heads of the colors such that an ink droplet ejected from each print head attached to the printing device 102 is landed in a desired correct position. A calibration adjustment function 902 is a function to perform calibration to maintain the constant color and density of the result printed on the printing medium. A calibration target creation function 903 is a function to create calibration target data used in the calibration adjustment function 902. The calibration target data is reference data for matching the printing state, and in a case where calibration is performed, computation is performed to match the printing state and the reference data. A calibration target is determined based on a combination of the ink and the printing medium; for this reason, the calibration target is created for each printing medium. Additionally, as illustrated in FIG. 5, the maximum density or the ink density change characteristics of each ink color is changed also in a case where the color ink amount to be applied is changed in the ink amount (color) 501. Therefore, it is desirable to perform the recreation of the calibration target and the adjustment of the calibration.

A color profile creation function 904 is a function to create the color profile of the printing medium. In the present embodiment, as illustrated in FIG. 5, in a case where the color ink amount to be applied is changed in the ink amount (color) 501, it is necessary to recreate the color profile since the color gamut of printing is changed. If the color profile is not recreated, a correct color matching result cannot be obtained, and it is impossible to reproduce a desired color. Therefore, it is characterized by the pop-up display illustrated in FIG. 7 that notifies the user that it is desirable to recreate the color profile in a case where the color ink amount to be applied is changed in the ink amount (color) 501. A checkbox of the color profile creation function 904 in FIG. 9 is checked in advance because it is the checkbox related to the function that is suggested to be performed by the user, and in this way the color profile creation is suggested to be performed by the user. Once all the adjustment functions to be performed are selected, an execute button 906 is pressed. The adjustment functions selected by the user are executed sequentially, and the results are stored.

Next, a flow of processing to display the pop-up display screen described above is described using a flowchart.

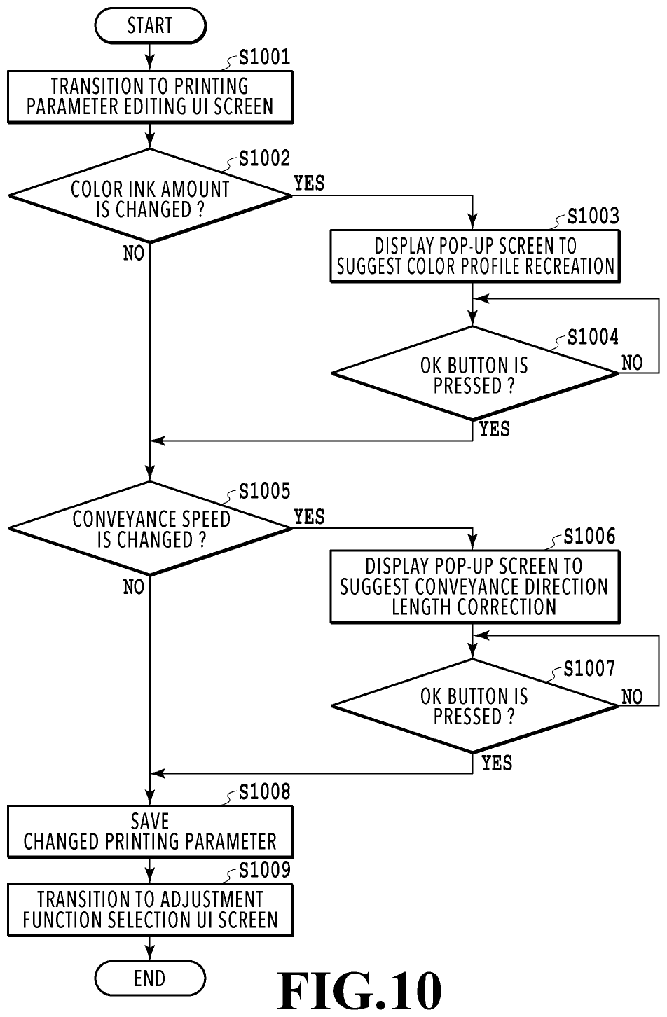

FIG. 10 is a diagram describing the processing to display the pop-up display screen. The present processing is started with the paper edit button 410 being pressed in the whole UI screen 400 illustrated in FIG. 4. First, in S1001, the control unit 204 of the image formation apparatus 100 allows for the transition to the printing parameter editing UI screen illustrated in FIG. 5. In the present embodiment, a case where the color ink amount is changed and a case where the conveyance speed is changed in the printing parameter editing UI are described.

In S1002, the control unit 204 determines whether the color ink amount is changed by the printing parameter editing operation by the user. If it is determined that the color ink amount is not changed, the control unit 204 allows the process to proceed to S1005. On the other hand, if it is determined that the color ink amount is changed, the control unit 204 allows the process to proceed to S1003 and displays the pop-up display screen that suggests the color profile recreation as illustrated in FIG. 7. Then, in S1004, the control unit 204 determines whether the OK button 701 is pressed. If it is determined that the OK button 701 is pressed, the control unit 204 closes the pop-up display screen and allows the process to proceed to S1005. Note that, although a mode in which the pop-up screen is kept being displayed until the user presses the OK button is assumed in S1004, it is not limited thereto, and a mode in which the pop-up screen is displayed for only a designated certain period of time may be applied.

In S1005, the control unit 204 determines whether the conveyance speed of the printing medium is changed by the printing parameter editing operation by the user. If it is determined that the conveyance speed is not changed, the control unit 204 allows the process to proceed to S1008. On the other hand, if it is determined that the conveyance speed is changed, the control unit 204 allows the process to proceed to S1006 and displays the pop-up display screen that suggests the conveyance length direction correction. Then, in S1007, the control unit 204 determines whether the OK button 801 is pressed. If it is determined that the OK button 801 is pressed, the control unit 204 closes the pop-up display screen and allows the process to proceed to S1008.

In S1008, the control unit 204 saves the edited printing parameter with the user pressing the save button 507. In S1009, the control unit 204 allows for the transition to the adjustment function selection UI screen illustrated in FIG. 9. Thereafter, the control unit 204 ends the processing of the present flowchart.

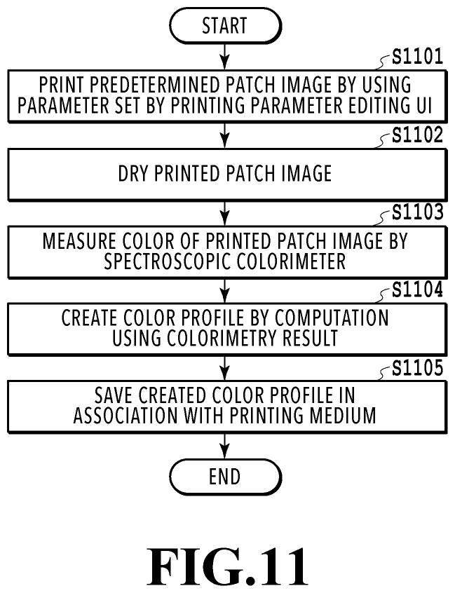

Next, the processing to create the color profile as one of the function adjustment operations is described. FIG. 11 is a flowchart related to the color profile creation. The present processing is started sequentially by pressing the execute button 906 in the adjustment function selection UI screen in FIG. 9.

First, in S1101, the control unit 204 of the image formation apparatus 100 prints the patch image for creating the color profile by using the printing parameter set in the printing parameter editing UI screen illustrated in FIG. 5. The patch image is a combination of some areas filled with determined colors. The size of each area is determined based on a colorimetry device of a colorimeter that measures the color thereof or a printing accuracy of the image formation apparatus 100. The size is about 5 mm×5 mm. A combination of those color patches covering the full gamut of colors of the image formation apparatus 100 is the patch image, and the necessary number or arrangement depends on a profile creation software.

In S1102, the control unit 204 dries the printed patch image. It is necessary to dry the printed patch image sufficiently. If the colorimetry is performed while the patch image is not sufficiently dried, it is impossible to measure an accurate color. Additionally, the undried ink must be prevented from being attached to the measuring instrument. Since the dryer that performs drying after printing is mounted in the image formation apparatus 100 described in the present embodiment, it is possible to perform high-speed drying. In an image formation apparatus with no drying function, it is necessary to sufficiently dry the patch image after printing by natural drying.

In S1103, the control unit 204 measures the printed and dried patch image by a spectroscopic colorimeter. Since it is assumed that the colorimeter is mounted in the image formation apparatus 100 of the present embodiment, it is possible to automatically measure the color of the color patch after printing. Once the colorimetry is completed, in S1104, the control unit 204 creates the color profile by computation processing using the colorimetry result. In S1105, the control unit 204 saves the created color profile in association with the printing medium and the printing parameter. Thereafter, the processing in the present flowchart ends.

As described above, according to the present embodiment, it is possible to improve the convenience in changing the parameter. Specifically, with the change of the printing parameter, the pop-up display screen that suggests the adjustment of other setting related to the changed parameter is displayed to the user. Thus, it is possible to notify the user of that the adjustment operation is necessary.

Next, a case where a parameter set desired by the user is searched from printing parameter sets registered with the image formation apparatus 100 in the present embodiment is described.

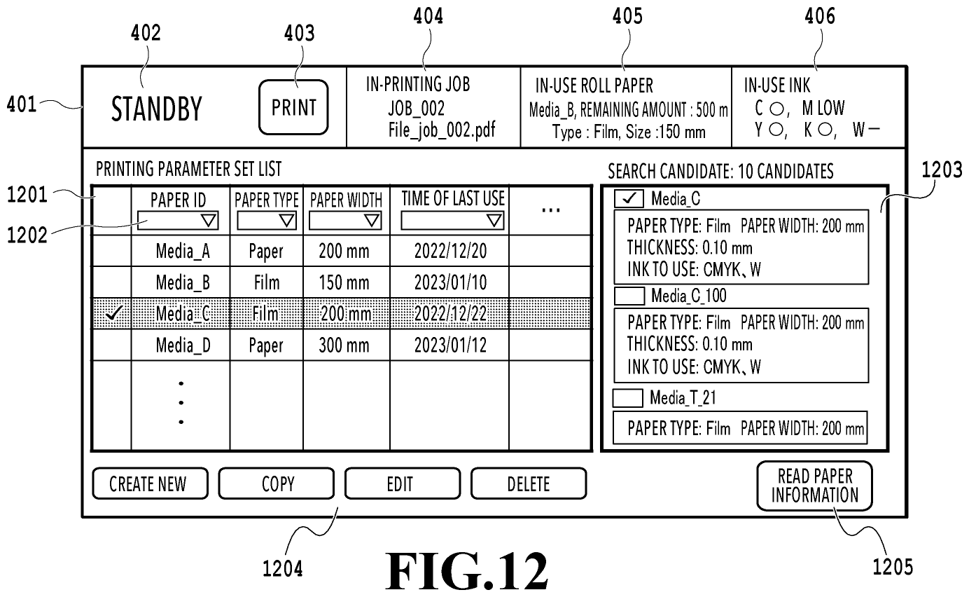

FIG. 12 is a UI screen of a printing parameter set list. For example, it is possible to switch the screen to the display of the printing parameter set list in FIG. 12 by pressing the printing medium information display 405 in the screen of the printing job list illustrated in FIG. 4. The printing parameter set list is a list screen displaying the combinations of all the printing parameters registered with the image formation apparatus 100 and also includes information registered by the printing parameter editing in FIGS. 5 to 11 described above. Additionally, individual parameter set is displayed in association with a usage record in printing. In FIG. 12, the same number is applied to a function same as that in FIG. 4.

A printing parameter set list 1201 is an example of the printing parameter set list registered in association with the printing medium. In association with an ID of the printing medium as an identifier, the characteristics of the printing medium, the optimal printing conditions of the printing medium, a usage record of the parameter set associated with the ID of the printing medium in printing, user management information, and so on are displayed on the printing parameter set list 1201. For example, the characteristics of the printing medium may include a material type, a roll paper width, a background color, a material thickness, a basis weight, and so on. The optimal printing conditions of the printing medium may include a printing speed, a color ink apply amount, a drying temperature after the color printing, whether to perform the white printing, a white ink apply amount, a drying temperature after the white printing, a color profile to be used, a tension, and so on as an example. The information related to the usage record may include time of the last use for printing, update time of the last update of the parameter, the number of times of usage for printing, and so on as an example. The user management information may include a management name of the printing medium, favorite setting of the printing medium that is used often, enabling and disabling setting of editing, displaying and non-displaying setting on the list, user comment setting, and so on as an example. Note that, although an example of the printing parameter is described above, it is not limited thereto, and setting in association with information related to post-processing or a delivered form is also possible.

In the printing parameter set list illustrated in FIG. 12, with a character string being inputted to filter setting 1202, or an arbitrary setting value being selected from options, it is possible to extract and display only the parameter set including the inputted value. Note that, in a case where a transition to the printing parameter set list screen in FIG. 12 is made from another screen, the screen is displayed while nothing is inputted to the filter setting 1202 of all the printing parameters.

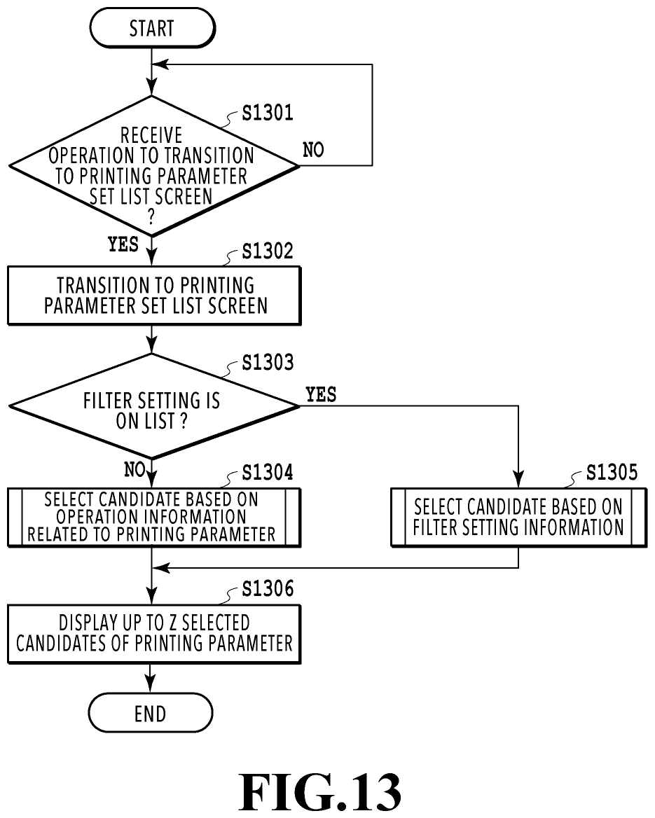

A printing parameter set candidate display region 1203 can display multiple printing parameter sets to be candidates of the one that the user tries to find out from the printing parameter set list 1201 according to the state of the filter setting 1202. Selecting of the candidates of the printing parameter sets to be displayed is described later with reference to FIG. 13. Additionally, the multiple printing parameters of each printing medium to be displayed may be extracted and arrayed to be principal parameters so as to be compared easily. Moreover, it is also possible to display the number of the displayed printing parameters as the candidates together, and a method of displaying multiple candidates is not limited thereto. An individual printing parameter set operation button group 1204 includes buttons to copy, edit, and delete the printing parameter selected from the printing parameter set list 1201 and a create new button to register a new printing parameter. For example, once the edit button is pressed, the printing parameter editing UI screen in FIG. 5 is displayed, and it is possible to change the individual printing parameter.

A paper information read button 1205 is a button similar to the paper information read button 411 in the screen of the printing job list illustrated in FIG. 4 and is used in a case of reading new paper information other than the paper information currently set. In the present embodiment, with placing a check mark on the printing parameter set list 1201, it is possible to execute the processing of the printing parameter set operation button group 1204 or the paper information read button 1205 on the checked parameter set. In addition, also in the printing parameter set candidate display region 1203, it is possible to execute the processing of the printing parameter set operation button group 1204 or the paper information read button 1205 on the parameter set with the check mark.

Thus, regardless of the operation skill or the understanding of the function of the user, it is possible to easily select and perform an operation on the printing medium information that has the paper information desired to be read and that is used in printing from now or the parameter set as a target of the copying, editing, or deleting operation.

FIG. 13 is a flowchart in which the printing parameter set associated with the printing medium as the candidate desired by the user is selected. In the present embodiment, it is assumed to be displayed in the printing parameter set candidate display region 1203 on the screen of the printing parameter set list in FIG. 12; however, for example, displaying on a pop-up screen may be applied, and a method of displaying the candidate is not limited to the present embodiment.

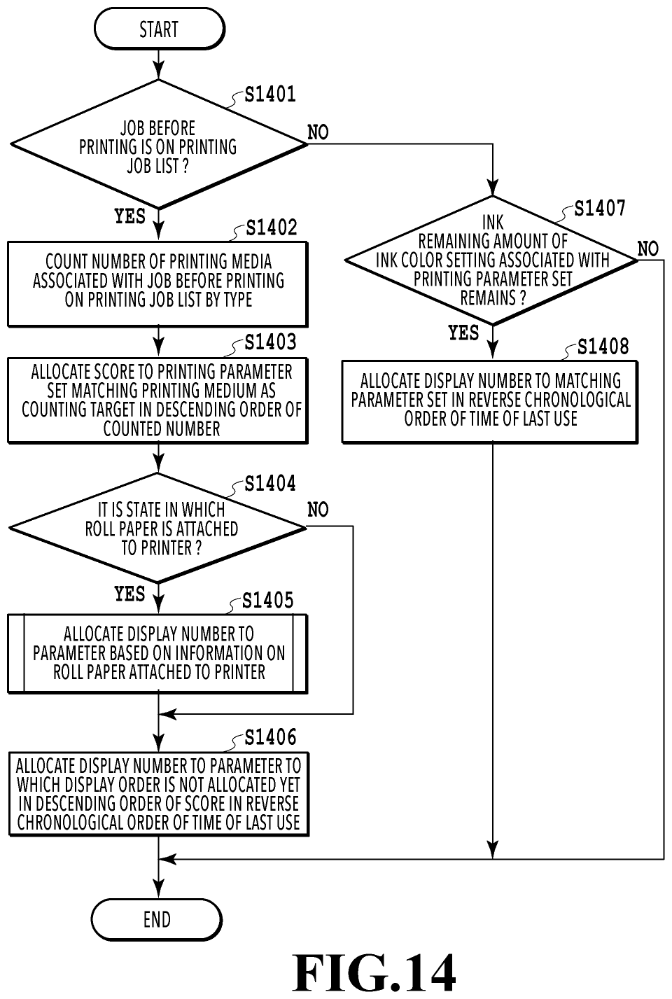

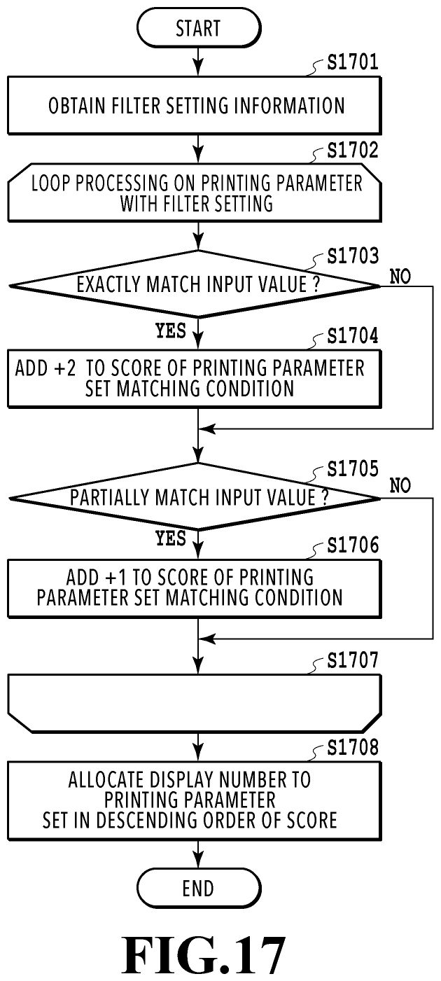

In S1301, the control unit 204 of the image formation apparatus 100 determines whether to receive an operation to transition to the screen of the printing parameter set list. If the transition operation is received, the control unit 204 allows the process to proceed to S1302 and allows for the transition to the screen of the printing parameter set list in FIG. 12. In the present embodiment, with the printing medium information display 405 being pressed, the transition operation in S1301 is received, and the screen is switched to the display of the printing parameter set list in FIG. 12 in S1302. Next, in S1303, the control unit 204 determines whether there is the input value in the filter setting 1202 on the printing parameter set list 1201. If there is no input value in the filter setting, the control unit 204 allows the process to proceed to S1304, obtains operation information related to the printing parameter, and selects the candidate of the printing parameter set based on the operation information. The operation information is information including information associated with the printing job, a consumption state of the printing medium or the printing material, a printing quality state of the deliverable, a maintenance state, and so on. Additionally, the operation information may be saved in a storage unit or the like of the image formation apparatus 100 or may be saved in an external device. The control unit 204 obtains the operation information from where the information is saved. Note that, a method of selecting the candidate of the printing parameter set based on the operation information is described later with reference to FIG. 14. On the other hand, if it is determined in S1303 that there is the input value in the filter setting, the control unit 204 allows the process to proceed to S1305 and selects the candidate of the printing parameter set based on filter setting information. Note that, a method of selecting the candidate based on the filter setting is described later with reference to FIG. 17. Once the candidate of the printing parameter set is selected in S1304 and S1305, and the order of displaying is defined, up to Z candidates of the printing parameter selected in S1306 are displayed in the printing parameter set candidate display region 1203. Note that, although the candidate is displayed by the reception of the screen operation as described in S1301 herein, it is not limited thereto, and the candidate may be displayed by the automatic detection of the printing medium by a sensor or the like mounted in the image formation apparatus 100.

As described above, in the present embodiment, whether the filter is inputted in the candidate selection, the candidate displayed in the printing parameter set candidate display region 1203 is different. In a case where the filter is used, it is possible to search for the candidate of the printing parameter set desired by the user by extracting the candidate matching the contents inputted to the filter.

On the other hand, a case where the filter is not used is considered. In a case where the user is not used to the operation and is not conversant with the extraction using the filter or a case where a transition to the screen of the printing parameter set list is made from another screen, for example, no filter setting has been done. Displaying of the candidate to be able to select the printing parameter efficiently for the user even in the above state with no filter setting is considered.

FIG. 14 is a flowchart in which the printing parameter set displayed in the printing parameter set candidate display region 1203 is selected in a case where no setting is performed for the filter. That is, it is a specific flowchart to select the candidate of the printing parameter set based on the operation information related to the printing parameter in S1304 in a case where no filter is inputted. In the present embodiment, an example of selecting the candidate by using information on the printing job list directly associated with the printing medium information, information on the roll paper attached to the image formation apparatus 100, or ink state information. However, it is not limited thereto, and the candidate may be extracted based on the printing quality state of the deliverable, the maintenance state of the main body, or the like.

First, in S1401, the control unit 204 of the image formation apparatus 100 determines whether there is a job in a state before printing in the current state of each job on the printing job list 408 illustrated in FIG. 4. Note that, although the operation information on the image formation apparatus 100 is determined based on the state before printing in the present embodiment, for example, it may be determined based on a state of data-saving to the main body, or other operation information may be used. It is not limited thereto. If there is no job before printing in S1401, the control unit 204 allows the process to proceed to S1407 and performs determination on the color information on the ink to be used that is associated with the printing parameter set on the printing parameter set list 1201 whether each color ink remaining amount remains. The present determination is processing to put priority to display in the candidate display region 1203 the parameter set that can perform printing with a current consumable supply remaining amount without taking time for replacement of the ink (the consumable supply). Accordingly, the determination is made based on each color ink remaining amount (the consumable supply consumption state) mounted in the image formation apparatus 100. If it is determined in S1407 that there is no remaining amount in all the ink colors, the process ends without performing processing. If it is determined in S1407 that there is an ink remaining amount, in S1408, in reverse chronological order of the time of last use, a display number is allocated to the parameter set in which the color information on the ink to be used that is associated with the printing parameter set matches the color of the remaining ink. This means that the candidate displayed by the present processing can perform printing by using the ink remaining in the image formation apparatus 100. After S1408 ends, the control unit 204 ends the processing in the present flowchart.

If there is the job before printing in S1401, the control unit 204 allows the process to proceed to S1402 and counts the number of the printing media by the types with reference to the printing medium information associated with each printing job ID of the job before printing. In the present embodiment, the number of the association with the job before printing is calculated for each combination of the material type (a paper type) and the roll paper width (a paper width) of the printing medium information. In the present embodiment, the printing medium with the greatest number of association is the one with the material type of Paper and the roll paper width of 200 mm. Additionally, the printing medium with the second greatest number of association is the one with the material type of Film and the roll paper width of 150 mm, and the printing medium with the third greatest number of association is the one with the material type of Film and the roll paper width of 200 mm.

In S1403, the control unit 204 allocates a score to the printing parameter set matching any one of those top three groups of the printing medium information as three points, two points, or one point from the top. For example, the score of the printing medium including the material type of Film and the roll paper width of 200 mm in the parameter set is one point.

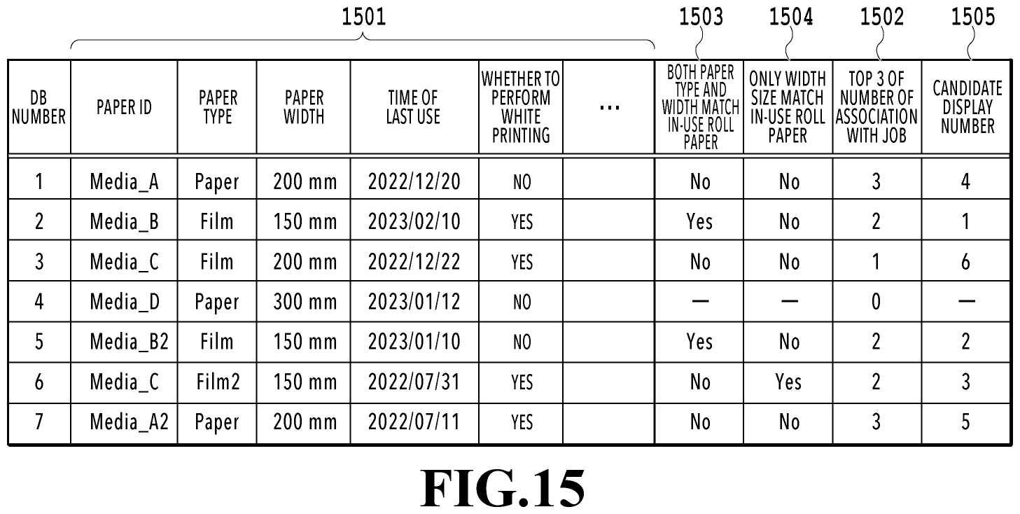

FIG. 15 is a diagram illustrating a candidate display order table in which the candidate display numbers are allocated based on the operation information on the image formation apparatus 100. In FIG. 15, first, a printing parameter set list 1501 and a field 1502 are described. The printing parameter set list 1501 in FIG. 15 matches the information displayed in the printing parameter set list 1201. The printing parameter sets that are displayed in FIG. 15 and correspond to the above-described top three groups are DB numbers 1, 2, 3, 5, and 7. An allocation result from S1403 is inputted to the field 1502 of “TOP 3 of number of association with job” of the printing parameter set. With reference to the field 1502, for example, since the DB number 2 corresponds to the material type of Film and the roll paper width of 150 mm, it is the printing medium of the second greatest number of association, and “2” is inputted. Note that, although FIG. 15 displays seven parameter sets of the DB numbers 1 to 7, the number of the displayed parameter sets is not limited thereto.

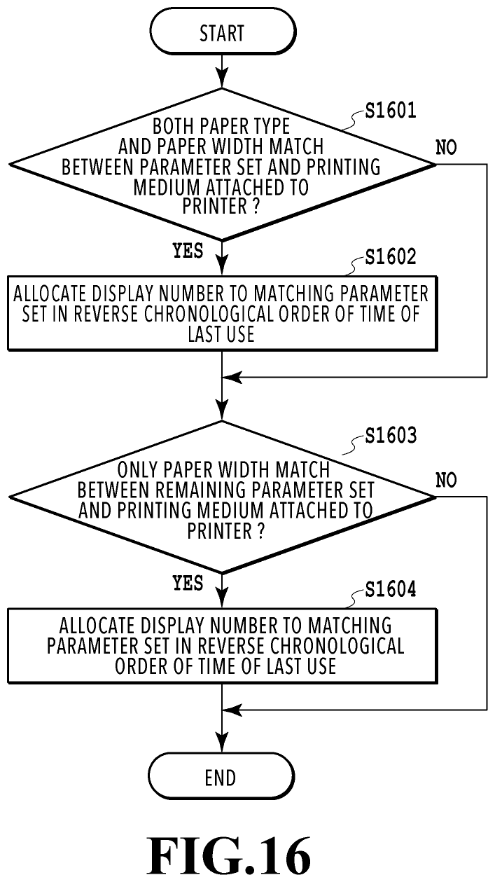

Next, in S1404, the control unit 204 determines whether it is a state in which the roll paper is attached to the image formation apparatus 100. In the present embodiment, as long as the name or the remaining amount of the printing medium is displayed in the printing medium information display 405, it is determined that it is a state in which the roll paper is attached to the image formation apparatus 100; however, it is not limited thereto, and the printing medium information detected by the sensor may be used. If the roll paper is attached to the image formation apparatus 100 in S1404, the control unit 204 allows the process to proceed to S1405 and allocates the candidate display number to the printing parameter set that matches the attached roll paper. A specific processing flow is described in FIG. 16.

FIG. 16 is a flowchart in which the candidate display number is allocated to the printing parameter set that matches the roll paper attached to the image formation apparatus 100 in S1405. In the present embodiment, the printing medium information displayed in the printing medium information display 405 is used; however, it is not limited thereto, and the printing medium information detected by the sensor may be used. Additionally, the information used for the determination is not limited to the roll paper information, and it may be scored based on the remaining amount information on the printing medium detected by the sensor; however, it is not limited thereto.

First, in S1601, the control unit 204 of the image formation apparatus 100 compares the attached printing medium with each parameter set (each of the parameter sets of the DB numbers 1 to 7). Then, it is determined whether there is the printing parameter set in which both the material type and the roll paper width match the printing medium. In the present embodiment, in this case, since it is possible to perform printing with the already attached printing medium, the determination is performed first. Specifically, once the width of the roll paper is changed, an operation to move a sensor or the like for detection in a width direction is added. Additionally, once the type of the roll paper is changed, tension adjustment and the like may be necessary in some cases. Accordingly, in order to omit the above operations, whether there is the parameter set that can perform printing by using the paper currently mounted is determined, and priority is put on the corresponding parameter set to be selected as the candidate. If it is determined in S1601 that there is the matching parameter set, the control unit 204 allows the process to proceed to S1602. On the other hand, if there is no matching parameter set, the process to proceeds to S1603.

In S1602, the control unit 204 allocates the display number to the printing parameter set that is determined in S1601 to include the material type and the roll paper width both matching the printing medium in reverse chronological order of the time of last use. In S1603, the control unit 204 compares the printing parameter set to which the display number is not allocated yet with the attached printing medium and determines whether there is the printing parameter set in which only the roll paper width matches the printing medium. If it is determined in S1603 that there is the printing parameter set in which only the roll paper width matches the printing medium, the control unit 204 allows the process to proceed to S1604 and allocates the display number in the order from a young number that is not allocated yet to the printing parameter set in reverse chronological order of the time of last use. Thereafter, the control unit 204 ends the processing in the flowchart in FIG. 16.

Here, referring back to FIG. 15. A field 1503 in FIG. 15 is a field indicating a result of the determination whether both the paper type and paper width match between the printing parameter set and the printing medium mounted in the image formation apparatus 100. As being displayed in the printing medium information display 405 in FIG. 4, since the roll paper of the material type of Film and the roll paper width of 150 mm is attached to the image formation apparatus 100, the printing parameter set in which both the material type and roll paper width match the printing medium corresponds to the DB numbers 2 and 5. Accordingly, as described in S1602, once the display number is allocated to the DB numbers 2 and 5 in reverse chronological order of the time of last use, a display number 1 is allocated to the DB number 2, and a display number 2 is allocated to the DB number 5 as illustrated in a field 1505 indicating the candidate display number. Additionally, a field 1504 in FIG. 15 is a field indicating a result of the determination whether the paper width matches between the printing parameter set and the printing medium mounted in the image formation apparatus 100. The printing parameter set in which the paper type does not matches Film, and the paper width matches 150 mm corresponds to the DB number 6. Therefore, once the display number is allocated to the DB number 6 as described in S1604, a display number 3 is allocated to the parameter of the DB number 6 as illustrated in the field 1505.

Referring back to FIG. 14. If there is the parameter to which the display number is not allocated in S1405, or if it is determined in S1404 that the roll paper is not attached to the image formation apparatus 100, the control unit 204 allows the process to proceed to S1406. In S1406, the control unit 204 allocates the candidate display number to the printing parameter set scored in S1403 in descending order of score in the order from a young number that is not allocated yet. Specifically, since no display number is allocated to the DB numbers 1, 3, and 7 yet in the field 1505 in FIG. 15, the display number is allocated in descending order of score in 1502 in FIG. 15 in S1406. In a case where the display number is allocated from reverse chronological order of the time of last use if there is a tie, a display number 4 is allocated to the DB number 1, a display number 5 is allocated to the DB number 7, and a display number 6 is allocated to the DB number 3. In a case where an upper limit of the candidates to be displayed is defined to five in S1306 in FIG. 13, the display numbers 1 to 5 in the field 1505 in FIG. 15 are displayed in sequence in the printing parameter set candidate display region 1203 in FIG. 12. Note that, as the upper limit of the candidates to be displayed, the display upper limit may be switched according to the size of an area of the displayed screen, and a method of defining the upper limit number is not limited thereto. Additionally, the order of the processing based on the job state in S1402 and S1403 and the processing based on the state of being attached to the image formation apparatus 100 in S1405 may be reversed in FIG. 14, and the order of the processing is not limited thereto. After S1406 ends, the control unit 204 ends the processing in the flowchart in FIG. 14.

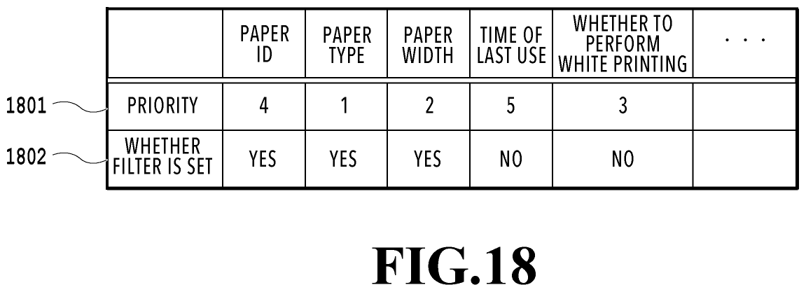

Next, FIG. 17 is a specific flowchart in which the candidate of the printing parameter set is selected based on the filter setting information in S1305 in FIG. 13. Additionally, FIG. 18 illustrates a priority definition 1801 of each type of the printing parameter regarding the displaying in the printing parameter set list 1201 and a field 1802 indicating whether the filter is set. In the priority definition 1801, a younger number is defined as a higher priority of the filter determination, and as the priority is higher, an effect in printing and an effect to the operation efficiency are higher. Note that, in the present embodiment, no weighting to each parameter based on the priority is performed.

In the present embodiment, it is described that it is a state in which the material type (the paper type) of Film, the roll paper width (the paper width) of 1 (100 to 199 mm), and the printing medium ID (the paper ID) of Media_B are inputted in the filter setting 1202 in FIG. 12. In the above-described case, as illustrated in the field 1802 in FIG. 18, it is a state in which the fields of the paper ID, the paper type, and the paper width that indicate whether there is the filter setting are “yes”.

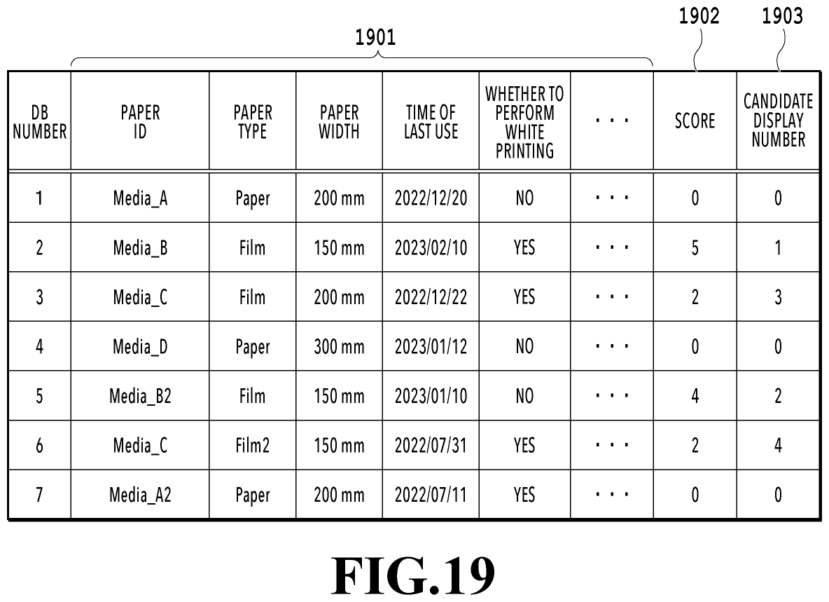

In addition, a counting result of each printing parameter reflecting a determination result or a calculation result from FIG. 17 is illustrated in FIG. 19. A field 1901 in FIG. 19 matches the information displayed in the printing parameter set list 1201.

First, in S1701, the control unit 204 of the image formation apparatus 100 obtains the filter setting information inputted in the filter setting 1202. In the present embodiment, the filter setting information in which the material type (the paper type) of Film, the roll paper width (the paper width) of 1 (100 to 199 mm), and the printing medium ID (the paper ID) of Media_B are inputted is obtained. In S1702 to S1707, the processing is performed repeatedly on the parameters as the filter setting target. The printing parameter set is scored depending on how much the parameter included in each printing parameter set in the printing parameter set list exactly matches or partially matches the filter input value. It is considered that the more the printing parameter set includes the parameters exactly or partially matching the filter input value, the closer the printing parameter set is to the candidate desired by the user. In the present embodiment, S1702 to S1707 are performed in the order of the paper type, the paper width, and the paper ID.

In S1703, the control unit 204 determines whether the parameter as the comparison target (for example, the paper type) exactly matches the filter input value included in the obtained filter setting information. If it is determined that the parameter exactly matches the filter input value, the control unit 204 allows the process to proceed to S1704 and adds two points to the printing parameter set including the parameter that exactly matches the filter input value. If it is determined that the parameter does not exactly match the filter input value, the control unit 204 allows the process to proceed to S1705 without adding.

In S1705, the control unit 204 determines whether the parameter as the comparison target (for example, the paper type) partially matches the obtained filter input value. If it is determined that the parameter partially matches the filter input value, the control unit 204 allows the process to proceed to S1706 and adds one point to the printing parameter set including the parameter that partially matches the filter input value. If it is determined that the parameter does not partially match the filter input value, the control unit 204 allows the process to proceed to S1707 without adding.

The above-described scoring is described more specifically with reference to FIG. 19. First, for the filter setting in which the paper type is “Film”, since the DB numbers 2, 3, and 5 exactly match, two points are added to the DB numbers 2, 3, and 5. Additionally, since the DB number 6 partially matches, one point is added to the DB number 6. Next, for the filter setting in which the paper width is 1 (100 to 199 mm), since the DB numbers 2, 5, and 6 partially match, one point is added to each DB number. At this point, the DB number 2 has three points, the DB number 3 has two points, the DB number 5 has three points, and the DB number 6 has two points. Next, for the filter setting in which the paper ID is Media_B, since the DB number 2 exactly matches, two points are added thereto, and since the DB number 5 partially matches, one point is added thereto.

Accordingly, once the processing to S1707 is all done eventually, as illustrated in the field 1902, the scores are as follows: the DB number 2 has five points, the DB number 3 has two points, the DB number 5 has four points, and the DB number 6 has two points. In the present embodiment, weighting processing is not performed; however, weighting may be performed in the order of priority of the priority definition 1801 in descending order of printing parameter having the highest effect in printing or the highest effect on the operation efficiency to achieve the scoring with better operation efficiency.

In S1708, the candidate display number is allocated in descending order of the scores in the field 1902. In a case where there is a tie, the display number is allocated in descending order of time of last use. As a result, as illustrated in a field 1903, the display number 1 is allocated to the DB number 2, the display number 2 is allocated to the DB number 5, the display number 3 is allocated to the DB number 3, and the display number 4 is allocated to the DB number 6. Therefore, in S1306 in FIG. 13, the candidates with the display numbers 1 to 4 in the field 1903 in FIG. 19 are displayed in the printing parameter set candidate display region 1203 in FIG. 12 in sequence. Note that, although the determination is performed on whether the filter setting input value and the parameter exactly match or partially match in the present embodiment, it is not limited thereto, and the determination may be performed by other approximate match such as prefix search and suffix search. After S1708 ends, the control unit 204 ends the processing in the present flowchart.

As described above, according to the present embodiment, it is possible to select the parameter set more efficiently. Specifically, in a case where the filter is used to extract the candidate of the printing parameter set to be used, the candidate is selected based on the filter input value. Additionally, even in a case where no value is inputted to the filter, it is possible to select the printing parameter set based on the printing operation information and display the printing parameter set in the candidate display field.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-089446, filed May 31, 2023, which is hereby incorporated by reference wherein in its entirety.

What is claimed is:

1. A printing control device, comprising:
an operation information obtainment unit that obtains operation information on a printing device; and
a display control unit that displays, on a display screen to select a parameter set, a candidate selected from a plurality of parameter sets registered with the printing device based on the operation information on the printing device.

2. The printing control device according to claim 1, wherein
the operation information includes information associated with a printing job, a consumption state of a printing medium or a printing material, a printing quality state of a deliverable, or a maintenance state.

3. The printing control device according to claim 2, wherein
the display control unit determines a parameter that is used more often by counting parameters of the printing medium associated with the printing job in a state before printing as the operation information and displays, as the candidate, a parameter set that includes a greater number of the determined parameters out of the plurality of parameter sets registered with the printing device.

4. The printing control device according to claim 2, wherein
the display control unit displays the candidate selected based on the printing medium mounted in the printing device.

5. The printing control device according to claim 2, wherein
the display control unit displays the candidate selected based on the printing material mounted in the printing device.

6. The printing control device according to claim 1, wherein
the displaying of the candidate by the display control unit is performed in a case where a transition to the display screen is made from another screen or a case where filter setting to select the candidate is not performed.

7. The printing control device according to claim 1, further comprising:
a filter setting information obtainment unit that obtains filter setting information to select the candidate, wherein
in a case where the filter setting information obtainment unit obtains the filter setting information, the display control unit displays, on the display screen, a parameter set that includes a greater number of parameters that each exactly match or partially match a setting value indicated by the obtained filter setting information as the candidate.

8. The printing control device according to claim 7, wherein
the display control unit further displays the parameter set, as the candidate, based on a priority that is set to the parameters that each exactly match or partially match the setting value indicated by the filter setting information.

9. The printing control device according to claim 1, wherein
the parameter set includes a paper ID, a paper type, a paper width, time of last use, or whether to perform white printing.

10. The printing control device according to claim 1, wherein
the display control unit displays a pre-set number of the candidates on the display screen.

11. A method of controlling a printing control device, comprising:
obtaining operation information on a printing device; and
displaying, on a display screen to select a parameter set, a candidate selected from a plurality of parameter sets registered with the printing device based on the operation information on the printing device.

12. A non-transitory computer readable storage medium storing a program which functions in a printing control device and causes the printing control device to function as:
an operation information obtainment unit that obtains operation information on a printing device; and
a display control unit that displays, on a display screen to select a parameter set, a candidate selected from a plurality of parameter sets registered with the printing device based on the operation information on the printing device.
